(19) United States
(12) Patent Application Publication
(10) Pub. No.: US 2008/0025281 A1
(43) Pub. Date: Jan. 31, 2008

(54) Device For A Radio Station

(75) Inventors: Simon Goedecke, Munchen (DE); Bernd Hassler, Illerkirchberg (DE); Armin Splett, Ulm (DE)

Correspondence Address: STAAS & HALSEY LLP, SUITE 700, 1201 NEW YORK AVENUE, N.W., WASHINGTON, DC, 20005, US

(73) Assignee: SIEMENS AKTINGESELLSCHAFT, 80333 MUNICH. GERMANY (DE)

(21) Appl. No.: 10/573,488

(22) PCT Filed: Aug. 31, 2004
(86) PCT No.: PCT/EP04/51964

§ 371 Date: Nov. 8, 2006

(30) Foreign Application Priority Data
Sep. 24, 2003 (DE) 10344278.2

(51) Int. Cl. H04B 7/216

(52) U.S. Cl. 370/342

(57) ABSTRACT

A device for a radio station has a first multiplexer provided with at least two inlets for receiving base hand data and an outlet for delivering base band data to an emission unit. The device is also provided with a first processing unit that is connected to the first inlet of the first multiplexer, for delivering first band data at a first data rate, for transmission by the emission unit according to a first radio standard, and a second processing unit that is connected to the second input of the first multiplexer, for delivering second base band data at the first data rate, for transmission by the emission unit according to a second radio standard.

### CROSS REFERENCE TO RELATED APPLICATIONS

This application is based on and hereby claims priority to PCT Application No. PCT/EP2004/051964 filed on Aug. 31, 2004 and German Application No. 10344278.2 filed on Sep. 24, 2003, the contents of which are hereby incorporated by reference.

### BACKGROUND OF THE INVENTION

The invention relates to a device for a radio station for processing first baseband data for a first radio standard and second baseband data for a second radio standard, and to a corresponding radio station.

Base stations used in radio communication systems generally require an interface between a baseband processing unit and a transmitting and receiving unit which modulates the baseband data supplied by the baseband processing unit onto carrier frequencies and then sends the data to subscriber stations. If the base station transmits data according to different radio standards, an interface between the respective baseband processing unit and a transmitting and receiving unit is required in each case for each standard. Thus, a data line is required between baseband processing unit and transmitting and receiving unit for each radio standard. In particular with a physically separate arrangement of baseband processing unit and transmitting and receiving unit, this requires a considerable overall length of all the data lines, which is to say a substantial investment in materials and correspondingly high costs. For example, the baseband processing unit may be located on the ground floor and the transmitting and receiving unit on the roof of a building. A data line several meters in length must then be laid for each radio standard.

### SUMMARY OF THE INVENTION

One possible object of the invention is therefore to specify a device for a radio station by which data of at least two different radio standards can be transmitted by the respective baseband processing unit to at least one transmitting unit via a single data line.

The inventors propose a device for a radio station is equipped with a first multiplexer having at least two inputs for receiving baseband data and one output for supplying baseband data to a transmitting unit, comprising a first processing unit, connected to the first input of the first multiplexer, for supplying first baseband data at a first data rate for a transmission by the transmitting unit according to a first radio standard, and comprising a second processing unit, connected to the second input of the first multiplexer, for supplying second baseband data at the first data rate for a transmission by the transmitting unit according to a second radio standard.

As a result of the fact that the first and second baseband data, i.e. data in the baseband of the respective radio standard, are supplied to the first multiplexer at a common first data rate, the first and second baseband data can be transmitted together over one connection, for example an electric cable or an optical waveguide, to the transmitting unit and modulated onto a carrier frequency by the latter in accordance with the respective radio standard. Preferably the first and second baseband data are modulated onto different carrier frequencies according to the radio standards, although the carrier frequencies can, of course, also be the same.

A preferred embodiment provides that the first multiplexer is embodied for assembling the first and second baseband data into a common data stream on the basis of individual bits. This permits a particularly simple structure of the first multiplexer, since only a counter is required in order to join the baseband data together bit-serially. Furthermore, only one counter is required also in order to separate the baseband data in the transmitting unit.

In an advantageous development, the second processing unit is embodied for forming the second baseband data from data blocks and filler data, the data blocks formed in each case of control data and useful data.

In this way the data blocks can already be formed such that they ideally have a format from which radio blocks can be formed which are used for transmitting data according to the second radio standard. The control data contain, for example, information relating to a carrier frequency that is to be used and to a transmitter power. The filler data enable the data rate of the second baseband data to be adapted in order to reach the first data rate if the data rate of the data blocks is not sufficiently high.

Advantageously each data block contains the number of useful data elements necessary to form precisely one radio block of the second radio standard. Radio blocks are used according to the second radio standard in order to send data from the transmitting unit to a subscriber station, for example a mobile telephone. In order to form a radio block, formed of, for example, guard periods, so-called tail bits, training sequences and the actual information data (e.g. audio data or video data), in other words to be able to modulate it onto a carrier frequency, a specific number of useful data elements are required. In this case more bits of useful data are required for forming a radio block than are subsequently transmitted in the radio block.

In a development the second baseband data N are assigned to different carriers of the second radio standard, where N is the integer portion of the quotient of a first data rate and a second data rate which is required as a minimum for forming radio blocks of a carrier according to the second radio standard. Different carriers of the second radio standards are distinguished from one another for example through the use of different carrier frequencies for the radio transmission and/or through the use of different antennas, for example sector antennas, which can transmit carriers of the same frequency in different spatial directions.

Advantageously, the data blocks (Bij) and filler data Fi0, Fi1, Fi2, Fi3, Fi4, Fi5, Fi6, Fi7) are formed such that during a period of the smallest common multiple of transmission frames which are used according to the first radio standard, and of radio blocks which are used according to the second radio standard, the same number of data blocks per carrier are supplied as radio blocks per carrier are transmitted.

In this way the baseband data required for data transmissions according to the two radio standards can successfully be supplied frame-synchronously to the transmitting and receiving unit. Frame-synchronously means that whenever the smallest common multiple of transmission frames according to the first radio standard and of radio blocks according to the second radio standard has elapsed, the two radio standards start in synchronism with a new frame. Frame, in this context, denotes transmission frames in the first radio standard and radio blocks in the second radio standard. The frame-synchronized delivery of the first and second baseband data permits a particularly simple construction of the device and of the transmitting unit.

In a preferred development, the size of the data blocks from which the second baseband data are formed is specified according to the formula

G=FLOOR(KGV*DR1/(N*ZFB))

where
FLOOR(X): integer portion of the value X,
KGV: smallest common multiple of transmission frames according to the first radio standard and of radio blocks according to the second radio standard,
DR1: first data rate in bit/s or in W bit/s, where W corresponds to the size of a word in the baseband of the second radio standard,
ZFB: the number of radio blocks according to the second radio standard corresponding to the period KGV, and
N: number of different carriers,
and the number of data elements still required per unit time in order to reach the first data rate are inserted as filler data between at least some of the data blocks.

The filler data inserted between data blocks cause delays in the reception of data blocks in the transmitting unit which result in delays in the subsequent transmission of radio blocks. In order to achieve the smallest possible delays in the transmitting unit it is advantageous if the second processing unit is embodied for time-equidistant bit-by-bit or word-by-word insertion of the filler data between the data blocks.

It is furthermore of advantage if the second processing unit has a second multiplexer having N inputs and one output, with data blocks and filler data for one of the N carrier frequencies in each case being received via each input, for generating the second baseband data through bit-by-bit or word-by-word assembling of the received data blocks and filler data.

In a preferred embodiment the first radio standard is the UMTS FDD standard and the second radio standard is the GSM standard.

The radio station comprises a transmitting unit and the device described above.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 is a schematic representation of a radio station comprising a device having a multiplexer for supplying first and second baseband data to a transmitting unit,

FIG. 2 is a schematic representation of a timing structure for transmission frames according to a first radio standard and for radio blocks for six different carrier frequencies of a second radio standard,

FIG. 3 is a schematic representation of two radio blocks of the second radio standard and a filler word according to FIG. 2.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

The same reference characters in the figures denote the same objects.

A radio station is, for example, a base station, a mobile telephone or even a mobile or stationary device for transmitting image and/or audio data, for fax, short message service SMS and e-mail transmissions and for internet access. A transmitting station is also a base station. In the following description a radio station will be referred to as a base station, but without being restricted thereto.

The device can advantageously be used in any radio communication systems. Radio communication systems are understood to mean systems in which a data transmission between stations is accomplished by way of a radio interface. The data transmission can be either bidirectional or unidirectional. Radio communication systems are in particular mobile radio systems conforming, for example, to the GSM (Global System for Mobile Communications) or the UMTS (Universal Mobile Telecommunications System) standard. Future mobile radio systems, of the fourth generation for example, are also to be understood as being included in radio communication systems.

The device is described in the following with reference to two mobile radio systems using two different radio standards, namely the UMTS standard and the GSM standard, though without being restricted thereto.

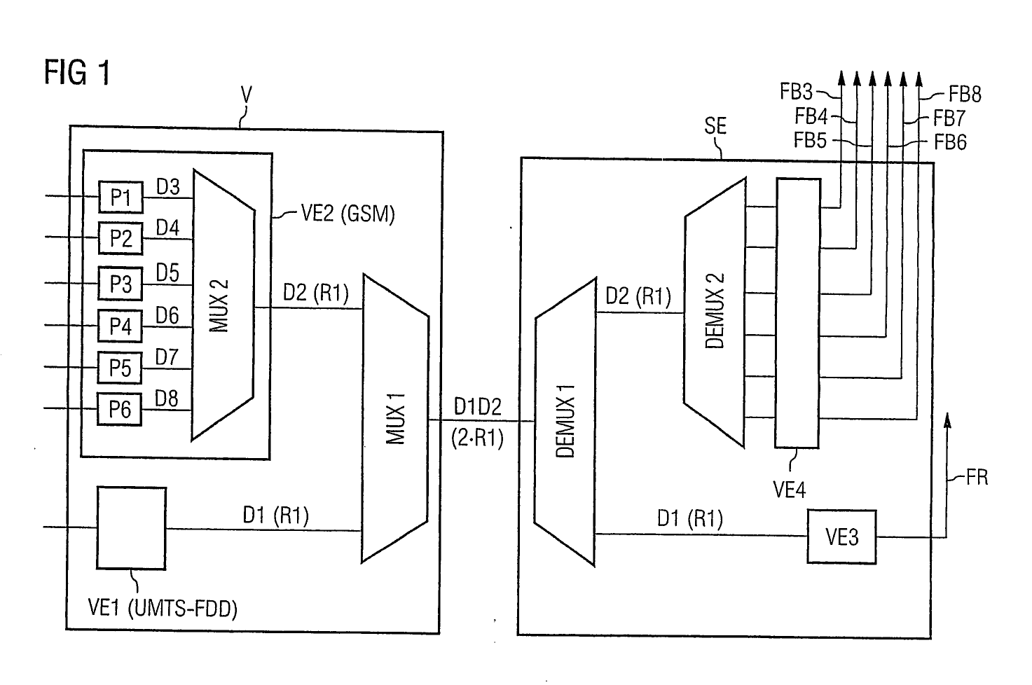

FIG. 1 is a schematic representation of components of a base station. Included in the base station is a device V which is connected to a transmitting unit SE via a line. Disposed in the device V is a first processing unit VE1 which supplies first baseband data D1 at a first data rate R1 to a first input of a first multiplexer MUX1. The first baseband data D1 are supplied by the first processing unit VE1 in a format of the UMTS FDD standard, said format being subdivided into transmission frames. A second processing unit VE2 supplies second baseband data D2, likewise at the first data rate R1, to a second input of the first multiplexer MUX1. For the purpose of generating the second baseband data D2, the second processing unit VE2 has six processors P1, P2, P3, P4, P5, P6 as well as a second multiplexer MUX2. Each of the six processors P1, P2, P3, P4, P5, P6 is connected to one of six inputs of the second multiplexer MUX2 and supplies to the respective input third, fourth, fifth, sixth, seventh and eighth baseband data D3, D4, D5, D6, D7, D8, which are provided for transmission on one carrier in each case, i.e. by a carrier frequency and/or by an antenna, according to the second radio standard.

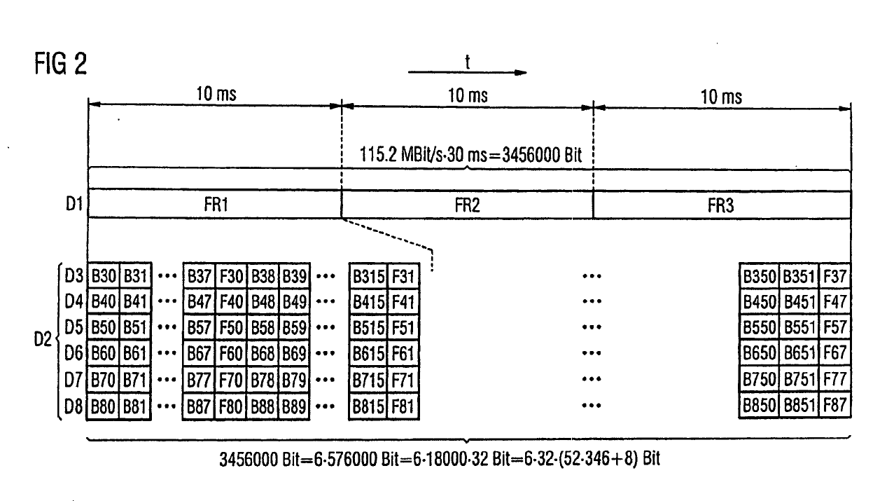

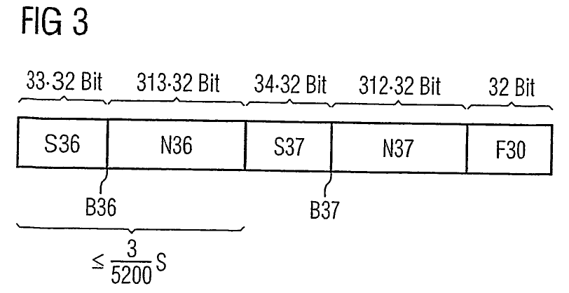

The baseband data D3, D4, D5, D6, D7, D8 supplied by the six processors P1, P2, P3, P4, P5, P6 are in each case already grouped into data blocks. The data blocks are formed of signaling data and useful data. The signaling data specifies, for example, at which frequency and with which transmitter power the radio blocks FB3, FB4, FB5, FB6, FB7, FB8 formed from the respective useful data of a data block in the transmitting unit SE according to the GSM standard are subsequently to be transmitted. In addition to data blocks, the baseband data D3, D4, D5, D6, D7, D8 present at the six inputs of the second multiplexer MUX2 also contain filler data. The purpose served by the filler data is that the first data rate R1 is present at each of the six inputs of the second multiplexer MUX2 ⅙. The structure of the data blocks, as well as the arrangement of the filler data, is described below with reference to FIGS. 2 and 3.

A common data stream D1D2 assembled bit by bit from the first baseband data D1 and the second baseband data D2 is present at the output of the first multiplexer MUX1 and is transmitted for example at double the first data rate R1 to the transmitting unit SE. The connection to the transmitting unit SE can of course be realized either via an electric cable or via an optical waveguide. A first demultiplexer DEMUX1 is present in the transmitting unit SE. The first demultiplexer DEMUX1 separates the received common data stream D1D2 into the first baseband data D1 and the second baseband data D2. The first baseband data D1 are subsequently modulated onto a carrier frequency by a third processing unit VE3 and transmitted in transmission frames FR via a transmit antenna.

The first demultiplexer DEMUX1 supplies the second baseband data D2 to a second demultiplexer DEMUX2 which separates the second baseband data D2 in turn into the third, fourth, fifth, sixth, seventh and eighth baseband data D3, D4, D5, D6, D7, D8 which were originally supplied to the six inputs of the second multiplexer MUX2 by the six processors P1, P2, P3, P4, P5, P6. In a fourth processing unit VE4, the respective filler data and the respective signaling data are then removed from the third, fourth, fifth, sixth, seventh and eighth baseband data D3, D4, D5, D6, D7, D8. From the useful data of the data blocks, the fourth processing unit VE4 forms radio blocks FB3, FB4, FB5, FB6, FB7, FB8 for six carriers according to the GSM standard which are then transmitted in each case by an antenna at a carrier frequency. Alternatively the six carriers can be transmitted by any number of antennas, for example one antenna, at six different carrier frequencies. With a plurality of antennas, at least some of the carrier frequencies used for the six carriers can be the same.

FIG. 2 shows a schematic illustrating the structure of the first baseband data D1 and the second baseband data D2. The first baseband data D1 are subsequently provided for transmission on a carrier frequency according to the UMTS FDD standard and are therefore arranged in transmission frames that are each 10 ms long. Radio blocks according to the GSM standard are 3/5200 seconds in length. The smallest common multiple of radio blocks and transmission frames thus has the value KGV=30 ms. In 30 ms, according to the UMTS FDD standard, three transmission frames FR1, FR2, FR3 are transmitted. In the same period, 52 radio blocks are transmitted on a carrier according to the GSM standard. The first baseband data D1 are transmitted at the first data rate of 115.2 Mbit/s, which means that 3,456,000 bits are transmitted in 30 ms. For a transmission of radio blocks on a carrier according to the GSM standard, a second data rate of, for example, at least 18 Mbit/s is required for a transmission of data blocks from which the radio blocks are formed.

A second data rate of precisely 18 Mbit/s per carrier in the baseband would be equivalent to a common data rate for six carriers of 108 Mbit/s, which means that there is a missing 7 Mbit/s for reaching the first data rate of 115.2 Mbit/s. As 7 Mbit/s is less than the minimum transmission rate for a carrier of 18 Mbit/s, the second baseband data D2 are formed from data blocks Bij for six carriers, where the i in the reference symbol Bij stands for the index for the third, fourth, fifth, sixth, seventh and eighth baseband data D3, D4, D5, D6, D7, D8 and the index j specifies the number of the respective data block during the time period KGV=30 ms. In 30 ms, i.e. during the time period of the smallest common multiple KGV, 52 data blocks are formed for each carrier, so the first baseband data D1 are frame-synchronized with the third, fourth, fifth, sixth, seventh and eighth baseband data D3, D4, D5, D6, D7, D8. Every 30 ms a data block of each carrier begins in synchronism with a transmission frame of the first baseband data D1.

All the data blocks that are provided for the six carriers, i.e. the data blocks contained in the third, fourth, fifth, sixth, seventh and eighth baseband data D3, D4, D5, D6, D7, D8, are chosen to be of equal size. The size of each data block is chosen such that the data rate of the data blocks for a carrier is greater than 18 Mbit/s. Filler data, for example bits with the value 0, are inserted between the data blocks, said bits being required in order to be able to use data blocks of equal size and in order to achieve an overall data rate of the data blocks and filler data of 115.2 Mbit/s. The use of equal-sized data blocks enables the transmitting unit to process each data block in the same way.

For a radio transmission according to the UMTS FDD standard, 3,456,000 bits are transmitted in the baseband in a period of 30 ms. This is equivalent to 108,000 32-bit words, so the equal-sized data blocks Bij of the third, fourth, fifth, sixth, seventh and eighth baseband data D3, D4, D5, D6, D7, D8 provided for a radio transmission according to the GSM standard are formed from 346 words in each case. This results from FLOOR((30 ms*3600000 words/s)/(6*52))=346 words, where the FLOOR function yields the integer portion of its argument. For the baseband data of each carrier, i.e. for the third, fourth, fifth, sixth, seventh and eighth baseband data D3, D4, D5, D6, D7, D8, in the time period of the smallest common multiple of 30 ms there remain in each case eight words, i.e. 8*32 bits, which are inserted as filler data Fi0, Fi1, . . . , Fi7 between data blocks in order to reach the first data rate of 115.2 Mbit/s with all six baseband data D3, D4, D5, D6, D7, D8 together. The filler data or filler words Fi0, Fi1, . . . , Fi5 are inserted time-equidistantly between data blocks Bij, i.e. the filler data Fi0, Fi1, . . . , Fi5 are inserted for each carrier after every eighth data block Bi7, Bi15, . . . , Bi47. The filler data Fi7 are inserted after the last data block Bi51 in each case. The structure of the data blocks Bij having 346 words is described below with reference to FIG. 3.

The data blocks Bij can, of course, also be specified so that they have the same bit size, i.e. the 3,456,000 bits are distributed bit by bit over the 6*52 data blocks Bij, and the remaining bits are inserted time-equidistantly between the data blocks Bij. With the filler data ideally being the same size, this means that, for each carrier, five bits are inserted in each case as filler data between the first 51 data blocks and one bit is inserted as a filler bit only after every 52nd data block.

FIG. 3 is a schematic depicting the seventh and eighth data block B36, B37 of the third baseband data D3 as well as the first filler word F30. All other filler words as well as the other data blocks of the third baseband data D3 and the data blocks of the fourth, fifth, sixth, seventh and eighth baseband data D4, D5, D6, D7, D8 are structured in the same way. The seventh data block B36 has control data S36 as well as useful data N36. The control data S36 are 33 words in size, i.e. 33*32 bits. The size of the useful data N36 is 313 words, i.e. 313*32 bits. The duration of the seventh data block B36 and of all the other data blocks Bij is somewhat less than the 3/5200 seconds of a radio block according to the GSM standard transmitted via the radio interface, since the filler words are still inserted between some of the data blocks Bij.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-11. (canceled)

12. A device for a radio station, comprising:
a first multiplexer having at least first and second inputs for receiving baseband data and one output for supplying baseband data to a transmitting unit;
a first processing unit connected to the first input of the first multiplexer, for supplying first baseband data at a first data rate for transmission by the transmitting unit according to a first radio standard; and
a second processing unit connected to the second input of the first multiplexer, for supplying second baseband data at the first data rate for transmission by the transmitting unit according to a second radio standard.

13. The device as claimed in claim 12, wherein
the first multiplexer assembles the first and second baseband data into a common data stream on the basis of individual bits.

14. The device as claimed in claim 12, wherein
the second processing unit forms the second baseband data from data blocks and filler data, the data blocks being formed in each case from control data and useful data.

15. The device as claimed in claim 14, wherein
radio blocks are transmitted according to the second radio standard, and
each data block identifies a number of useful data elements required to form precisely one radio block.

16. The device as claimed in claim 15, wherein
the second baseband data is assigned to N different carriers within the second radio standard, where N is an integer portion of a quotient of the first data rate and a second data rate which is required as a minimum to form radio blocks for transmission according to the second radio standard.

17. The device as claimed in claim 15, wherein
transmission frames are transmitted according to the first radio standard,
the data blocks and filler data are formed in such a way that during a time period of a smallest common multiple of transmission frames transmitted and radio blocks transmitted, the number of data blocks supplied per carrier equals the number of radio blocks transmitted.

18. The device as claimed in one of the claims 16, wherein
the data blocks used to from the second baseband data have a size determined according to the formula:
G=FLOOR(KGV*DR1/(N*ZFB))
where
FLOOR(X): integer portion of a variable X,
KGV: smallest common multiple of number of frames transmitted according to the first radio standard and number of radio blocks transmitted according to the second radio standard,
DR1: first data rate in bit/s or in W*bit/s, where W corresponds to a size of a word in a baseband of the second radio standard,
ZFB: number of radio blocks used to calculate KGV, and
N: number of different carriers, and
filler data is inserted so that a sum of a filler data rate and a data element rate approximately equals the first data rate.

19. The device as claimed in one of the claims 17, wherein
pieces of filler data are inserted equidistantly spaced in time between data block, and the filler data is inserted bit-by-bit or word-by-word.

20. The device as claimed in claim 17, wherein
the second baseband data is assigned to N different carriers within the second radio standard, where N is an integer portion of a quotient of the first data rate and a second data rate which is required as a minimum to form radio blocks for transmission according to the second radio standard,
the second processing unit has a second multiplexer having N inputs and one output, and
each of the N inputs receives data blocks and filler data for one of the N carriers, for generating the second baseband data through bit-by-bit or word-by-word assembling of data blocks and filler data.

21. The device as claimed in claim 12, wherein the first radio standard is a UMTS FDD standard and the second radio standard is a GSM standard.

22. The device as claimed in claim 13, wherein
the second processing unit forms the second baseband data from data blocks and filler data, the data blocks being formed in each case from control data and useful data.

23. The device as claimed in claim 22, wherein
radio blocks are transmitted according to the second radio standard, and
each data block identifies a number of useful data elements required to form precisely one radio block.

24. The device as claimed in claim 23, wherein
the second baseband data is assigned to N different carriers within the second radio standard, where N is an integer portion of a quotient of the first data rate and a second data rate which is required as a minimum to form radio blocks for transmission according to the second radio standard.

25. The device as claimed in claim 24, wherein
transmission frames are transmitted according to the first radio standard,
the data blocks and filler data are formed in such a way that during a time period of a smallest common multiple of transmission frames transmitted and radio blocks transmitted, the number of data blocks supplied per carrier equals the number of radio blocks transmitted.

26. The device as claimed in one of the claims 25, wherein
the data blocks used to from the second baseband data have a size determined according to the formula:
G=FLOOR(KGV*DR1/(N*ZFB))
where
FLOOR(X): integer portion of a variable X,
KGV: smallest common multiple of number of frames transmitted according to the first radio standard and number of radio blocks transmitted according to the second radio standard,
DR1: first data rate in bit/s or in W*bit/s, where W corresponds to a size of a word in a baseband of the second radio standard,
ZFB: number of radio blocks used to calculate KGV, and
N: number of different carriers, and
filler data is inserted so that a sum of a filler data rate and a data element rate approximately equals the first data rate.

27. The device as claimed in one of the claims 26, wherein
pieces of filler data are inserted equidistantly spaced in time between data block, and
the filler data is inserted bit-by-bit or word-by-word.

28. The device as claimed in claim 27, wherein
the second processing unit has a second multiplexer having N inputs and one output, and
each of the N inputs receives data blocks and filler data for one of the N carriers, for generating the second baseband data through bit-by-bit or word-by-word assembling of data blocks and filler data.

29. The device as claimed in claim 28, wherein the first radio standard is a UMTS FDD standard and the second radio standard is a GSM standard.

30. A radio station comprising:
a transmitting unit; and
a device comprising:
a first multiplexer having at least first and second inputs for receiving baseband data and one output for supplying baseband data to a transmitting unit;
a first processing unit connected to the first input of the first multiplexer, for supplying first baseband data at a first data rate for a transmission by the transmitting unit according to first radio standard; and
a second processing unit connected to the second input of the first multiplexer, for supplying second baseband data at the first data rate for a transmission by the transmitting unit according to second radio standard
